(19) United States
(12) Patent Application Publication
(10) Pub. No.: US 2003/0030844 A1
(43) Pub. Date: Feb. 13, 2003

(54) Method of generating image data for printing, apparatus of the same, and program

(75) Inventor: Shinzo Matsui, Kitatsuru-gun (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 10/207,143

(22) Filed: Jul. 29, 2002

(30) Foreign Application Priority Data
Aug. 7, 2001 (JP) 2001-239356

(51) Int. Cl. B41J 1/00; G06F 15/00

(52) U.S. Cl. 358/1.15

(57) ABSTRACT

Input information including a button is input from a storage section or a communication section according to an operation of an input section. The input information is stored as information to be printed in RAM. A CPU detects the button from the information to be printed. Information corresponding to the detected button is coded, thereby generating a coded image. The coded image is arranged near the detected button in the information to be printed, and then output for printing to a printing medium through a printing engine.

### CROSS-REFERENCE TO RELATED APPLICATIONS

This application is based upon and claims the benefit of priority from the prior Japanese Patent Application No. 2001-239356, filed Aug. 7, 2001, the entire contents of which are incorporated herein by reference.

### BACKGROUND OF THE INVENTION

1. Field of the Invention

The present invention relates to a method of generating image data for printing and an apparatus for the same. The method generates image data for printing from information so as to print the information on a printing medium. The present invention also relates to a program to work a computer as a printing image data generating apparatus of this kind.

2. Description of the Related Art

Conventionally, a variety of information that can be processed by a computer, such as voice, image, text, etc., is recorded on a recording (printing) medium such as paper in the form of optically readable coded image, such as one- or two-dimensional barcodes. This technology has been disclosed in U.S. Pat. Nos. 5,896,403, 5,866,895, etc.

FIG. 1 shows a physical format configuration for a dot code that is a coded image disclosed in these publications.

This dot code 1 comprises a plurality of blocks adjacently arranged in a two-dimensional manner. Each block 2 contains a data area 3 in which black and white dot images are provided in a specified two-dimensional array. Data including voice etc., to be recorded is divided into blocks, each of which is represented as a black dot or a white dot corresponding to values “1” or “0” of a block of data. It should be noted that a white dot in FIG. 1 is equivalent to the color of the recording medium itself. Further, each block 2 includes a marker area, a pattern dot 6, and a block address pattern (block ID area) 7. The marker area contains a marker 5 which comprises a specified number of sequential black dots and is placed at the four corners of each block used for finding a reading reference point to read each dot (data dot 4) in the data area 3. The pattern dot 6 is a set of independent dots placed between markers 5 and is used for more accurately finding the reading reference point. The block address pattern 7 contains an error detection or correction code and is also placed between markers 5 for identifying each block 2. The marker 5 and the pattern dot 6 are surrounded by a completely white no-dot area 8 for easily detecting them.

There may be a case where the whole dot code 1 is larger than the visual field 9 of the reader, in other words, the dot code 1 cannot be picked up with a one-shot operation. Even in this case, the dot code 1 makes it possible to reconstruct the whole original data by collecting data contained in each block 2. For this purpose, an address given to each block 2 should be detected together with data dots 4 contained in the block on a block basis. This also enables recording of large amounts of data, such as voice, on the paper and easily reading that data by manual scanning. Further, the arrangement of the blocks can be set arbitrarily, which makes it possible to arrange the blocks while varying the size of the whole dot code 1.

However, it is necessary to input information, which is to be recorded as a coded image that can be optically read such dot code 1 as described above, from a data file that is prepared beforehand, or input the information by keying on another occasion. That is, there has been a problem that it takes time to input information, which is to be recorded as a coded image that can be optically read, and that is therefore troublesome.

### BRIEF SUMMARY OF THE INVENTION

The present invention has been developed to resolve the above problem, and an object of the invention is to provide a printing image data generating method, when the coded image is generated, which enables the reduction of time for inputting information to be printed as a coded image and thus easy preparation of printed matter including a coded image while reducing input mistakes, a printing image data generating apparatus, and a program thereof.

According to a first aspect of the present invention, there is provided a printing image data generating method for generating printing image data from information to be printed so as to print the information on a printing medium, comprising:

detecting predetermined information from the information to be printed; and

coding one of the detected predetermined information and information corresponding to the detected predetermined information, thereby generating data of a coded image that can be optically read.

According to a second aspect of the present invention, there is provided a printing image data generating apparatus for generating printing image data from information to be printed so as to print the information on a printing medium, comprising:

a detecting section for detecting predetermined information from the information to be printed; and

a coded image data generating section for coding one of the predetermined information detected at the detecting section and information corresponding to the predetermined information detected at the detecting section so as to generate data of a coded image that can be optically read.

According to a third aspect of the present invention, there is provided a program for causing a computer to realize the following functions at the time of generating printing image data from information to be printed so as to print the information on a printing medium, the functions comprising:

detecting predetermined information from the information to be printed; and

coding one of the detected predetermined information and information corresponding to the detected predetermined information so as to generate data of a coded image that can be optically read.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate a embodiment of the invention and, together with the general description given above and the detailed description of the embodiment given below, serve to explain the principles of the invention.

FIG. 1 is a diagram showing a physical format for a dot code that is an example of a coded image;

FIG. 2 is a block diagram showing a configuration of an embodiment of the invention;

FIG. 3 is a flowchart for explaining a program that is used for realizing each function as a printing image data generating apparatus according to an embodiment of the invention;

FIG. 4 is a diagram showing a display example of a HTML file as an example of information to be input;

FIG. 5 is a diagram indicating the state of a square of the contour form shown in the form of a model, in which a coded image data are displayed under detected buttons;

FIG. 6 is a diagram showing a printing medium as a result of printing output;

FIG. 7 is a subroutine flowchart of the step S01;

FIG. 8 is a diagram showing a basic setting display for automatically button generation;

FIG. 9 is a diagram indicating the state of a square of the contour form shown in the form of a model is displayed, in which a coded image data are displayed under buttons, which are generated by the basic setting;

FIG. 10 is a diagram showing a display example in which an index is arranged;

FIG. 11 is a diagram sowing a logical data structure for a dot code that is an example of a coded image;

FIG. 12A and FIG. 12B are diagrams showing specific examples of predetermined information (buttons) in information to be printed, the output control data corresponding to the predetermined information, transmission control data, and user's data;

FIG. 13 is a subroutine flowchart of the step S04;

FIG. 14 is a subroutine flowchart of the step S06; and

FIG. 15 is a diagram showing an example of basic setting display for code printing.

### DETAILED DESCRIPTION OF THE INVENTION

An embodiment of the invention now will be described with reference to the accompanying drawings.

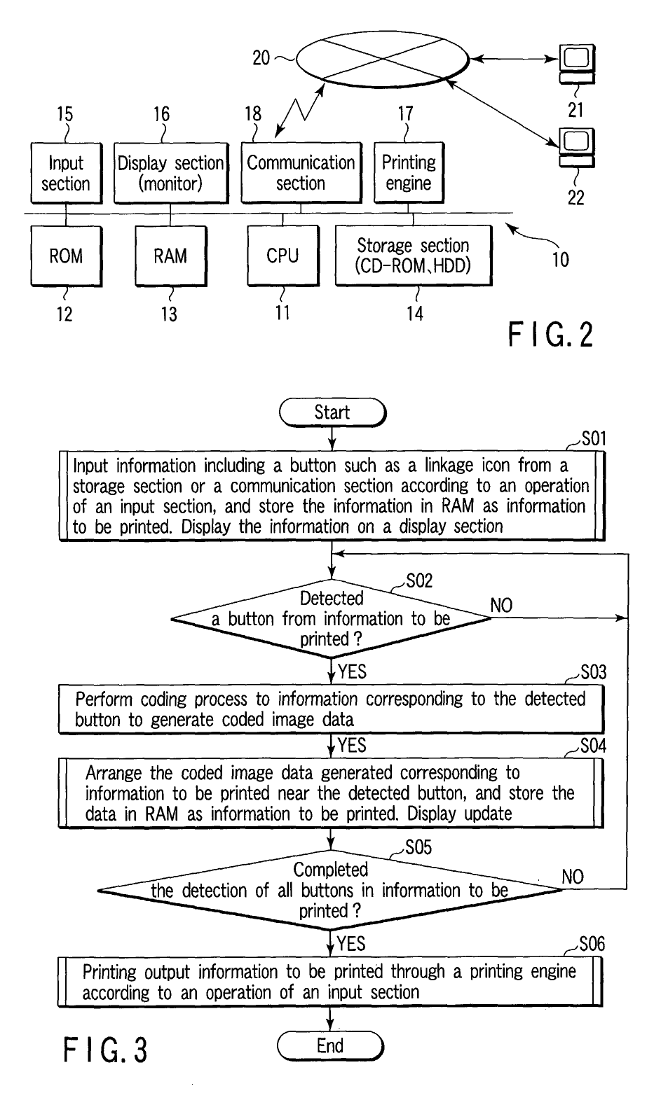

As shown in FIG. 2, a PC (Personal Computer) 10, which is an embodiment of a printing image data generating apparatus according to the invention, is constituted by a CPU (Central Processing Unit) 11, a ROM (Read-Only Memory) 12, a RAM (Random-Access Memory) 13, a storage section 14, an input section 15, a display section 16, a printing engine 17, and a communication section 18.

In this embodiment, the CPU 11 controls the respective sections in the PC 10.

The ROM 12 is a fixed memory that stores programs and parameters beforehand. The RAM 13 is a work memory to temporarily store application programs that are executed in the CPU 11, input data, etc. The storage section 14 includes storage media such as a CD-ROM (Compact Disc Random-Access Memory), an HDD (Hard Disk Drive), etc., and storages application programs and various data files.

The input section 15 includes a pointing device such as a mouse, and a keyboard. The display 16 is a monitor constituted by a CRT, liquid crystal, etc. The printing engine 17 is a printer for printing information on a printing medium.

The communication section 18 includes a modem, a TA (Terminal Adapter), etc, and is used for accessing a target site 21 or a conversion server 22 that is an information resource through the Internet 20. The target site provides a preferred homepage that an operator desires to read, for example. The conversion server 22 converts an individual identification code that is supplied from an access apparatus such as PC etc. accessing the conversion server 22 into a URL (Uniform Resource Locator) of a site on the Internet 20 so as to make the access apparatus read the site having the URL, as disclosed in Jpn. Pat. Appln. KOKAI Publication No. 10-171758.

Next, an operation in the configuration described above will be described with reference to the accompanying drawings.

FIG. 3 is a flowchart for explaining a program used for making the PC 10 realize each function of a printing image data generating apparatus according to an embodiment of the invention. The program will be described in an example in which the CPU 11 is stored in the storage section 14 in the form of a program code that can be read. However, it is not necessary to store all of the functions in the storage section 14. If necessary, it may be configured that a program, which realizes a part of, or all of the functions, is received by the communication section 18 from the other apparatus connected to a network such as the Internet 20, a WAN (Wide-Area Network), a LAN (Local Area Network), etc., and executed.

That is, input information including buttons, which are a piece of predetermined information, is firstly input from the storage section 14 (if necessary, from the communication section 18) according to an operation of the input section 15, and then the input information is stored in the RAM 13 as information to be printed and is displayed on the display 16 (Step S01).

The input information includes an HTML (Hypertext Markup Language) file, a document file, a spreadsheet file, a printing design file, etc. Further, the input information includes control information other than information to be displayed or printed.

The buttons, which are a piece of the predetermined information, are linkage icons, so called, to instruct to acquire or communicate each information such as an HTML file stored in the ROM 12, the RAM 13 or the storage section 14 or transmitted/received through the communication section 18. In addition, the buttons may be an operation menu that performs various settings in the application program.

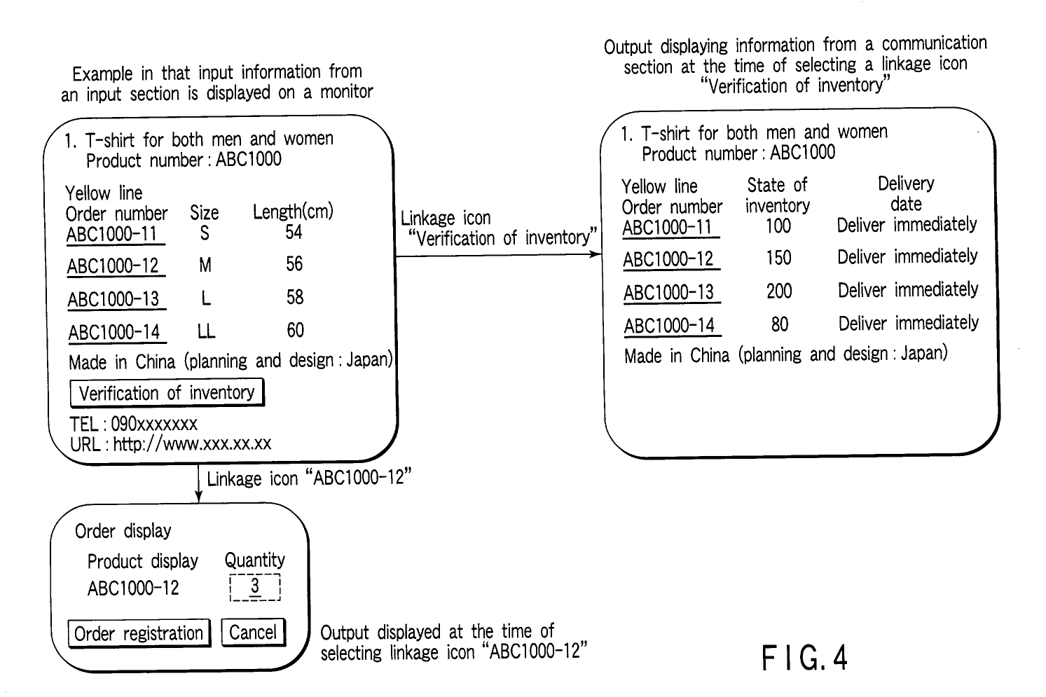

Through the process in Step S01, a display shown on the upper-left side in FIG. 4 is performed on the display 16, for example. This example shows the case where input information is an HTML file. As shown in the form of underlines or a frame line, the HTML file includes 5 buttons (Linkage icons) of “ABC1000-11”, “ABC1000-12”, “ABC1000-13”, “ABC1000-14”, and “verification of inventory”. In FIG. 4, as is well known, when the button “ABC1000-12” is selected and operated by the input section 15, for example, the CPU 11 reads a URL associated with the button “ABC1000-12” from the HTML file beforehand, and then accesses the target site 21 shown with the URL through the communication section 18. Then, the CPU 11 receives a new HTML file and displays the received file on the display 16 as shown on the lower-left side in FIG. 4. When the button “verification of inventory” is selected and operated through the input section 15, for example, the CPU 11 reads a URL associated with the button “verification of inventory” from the HTML file beforehand, and accesses the target site 21 shown with the URL through the communication section 18. Then, the CPU 11 receives a new HTML file and displays the received file on the display 16 as shown at the top of the right hand side in FIG. 4.

After ending the process in Step S01, the CUP 11 detects the button from information to be printed, which is stored in the RAM 13 and displayed on the display 16 (Step S02).

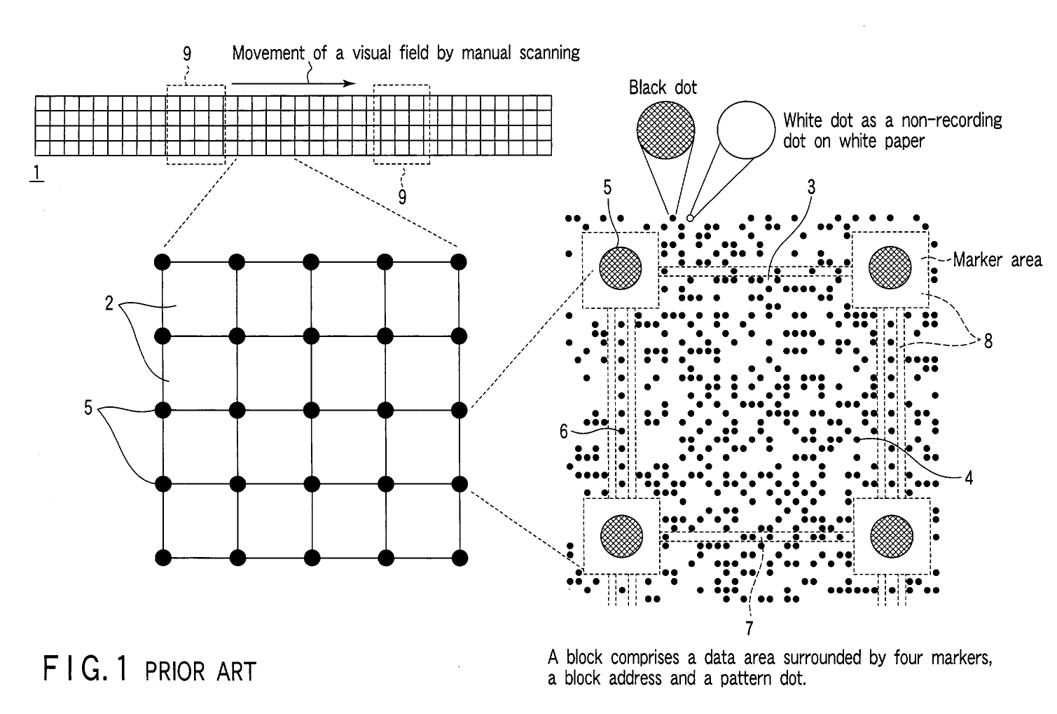

When the button is detected, the information corresponding to the detected button is processed by the known method, thereby generating image data of a coded image that can be optically read (Step S03). In this case, the image data to be generated may be image data of the dot code 1 shown in FIG. 1, or one of the known one-dimensional barcodes. In the example shown in FIG. 4, the information corresponding to the detected button is a URL that is linkage information. The URL may be coded directly and thus generates coded image data. Alternatively, as disclosed in the Jpn. Pat. Appln. KOKAI Publication No. 10-171758, a uniform identification code corresponding to the URL that can be converted through the conversion server 22 may be coded, thereby generating coded image data. Note that a URL of the conversion server 22 is stored in the ROM beforehand and the access to the conversion server 22 is carried out by reading the stored URL. At this time, a further access to the target site 21 is carried out by the conversion server 22 to which the identification code is transmitted.

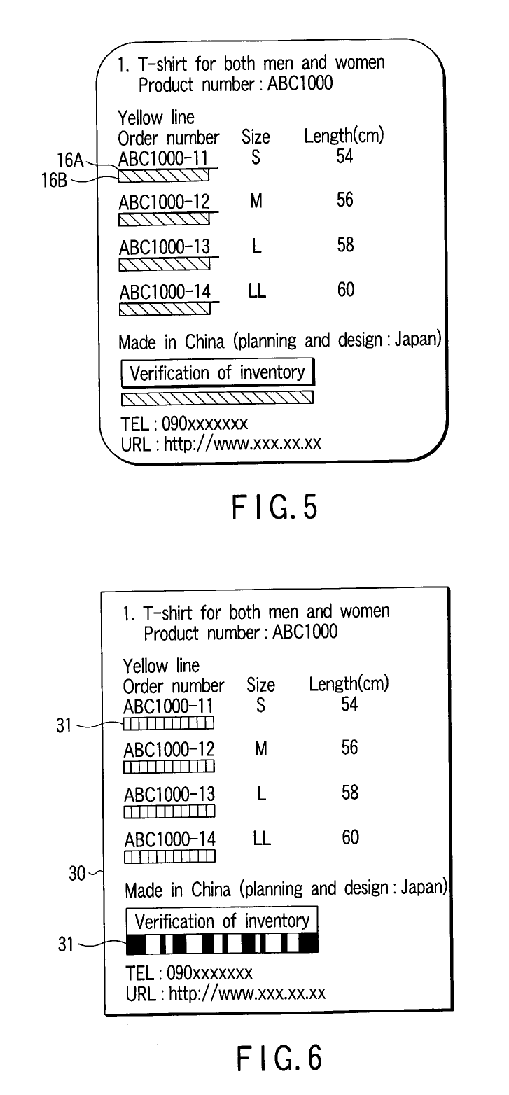

Next, the information to be printed from which the coded image data is generated, is corrected to arrange the generated coded image data near the detected button, and then the corrected information is stored in the RAM 13 again as information to be printed and is displayed on the display 16 so as to update an indication on the display 16 (Step S04). In the indication, as shown in FIG. 5, a square 16B of the contour form is displayed. In the square, the coded image data are shown in the form of a model near or under the detected button 16A, for example. In this case, coded image data to be generated are generated to have the same width as one of the detected button 16A, and therefore, the square 16B corresponding to the data is displayed with the same width as the button 16A. That is, when predetermined information is text information such as the button, it is preferable to set the length of a coded image arranged under the text information to have the substantially same length as the text information.

After that, it is determined whether or not all of the buttons in the information to be printed, the information stored in the RAM 13 and displayed on the display 16, are detected (Step S05). When the detection has not been ended, the process returns to step S02 so as to detect the next button.

When all of the buttons are detected, information to be printed, which is stored in the RAM 13 and displayed on the display 16, is output for print (printing) on a printing medium by the printing engine 17 according to an operation of the input section 15 (Step S06). Accordingly, as shown in FIG. 6, a coded image 31 is printed under each button that is predetermined information together with information of the HTML file.

Incidentally, according to the present embodiment, in addition to buttons, which are included in input information beforehand in the manner described above, preferable information included in the input information, which is set arbitrarily by the operator, can be also printed and recorded as a coded image on a printing medium. This is provided by an automatically button generating function that turns the preferable information in the input information into buttons in the process of Step S01.

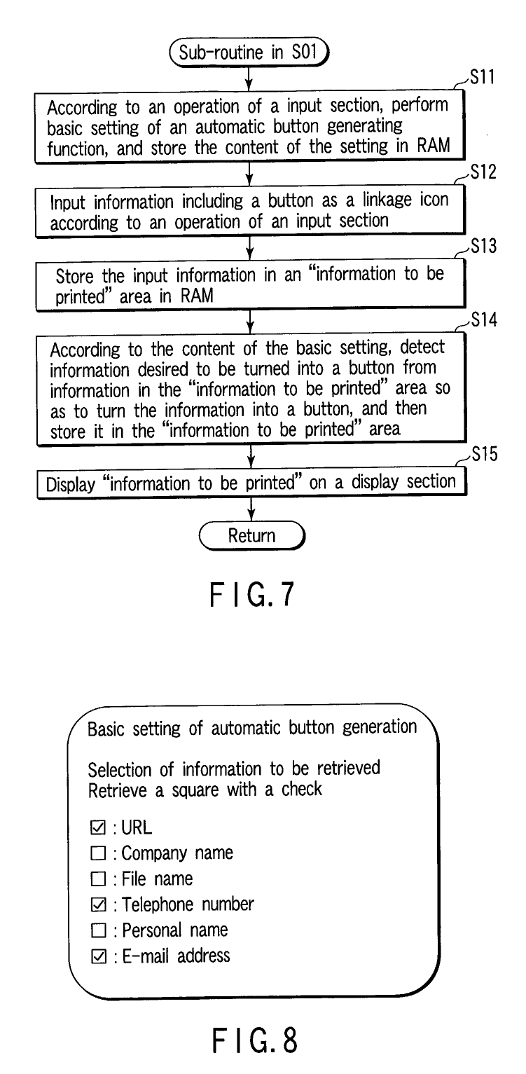

FIG. 7 shows the details of the process in Step S01.

That is, the automatic button generating function is set basically according to an operation of the input section 15, thereby storing the set content in the RAM 13 (Step S11). This process is to select information (such as a URL, a telephone number, and an E-mail address) or cancel the selection, which is preferred by the operator, on a basic setting display of the automatic button generation as shown in FIG. 8. The selected information is stored as the preferred information in the RAM 13.

Next, information including buttons such as linkage icons is input from the storage section 14 or the communication section 18 according to an operation of the input section 15 (Step S12). The input information is stored in an area of “information to be printed” on the RAM 13 (Step S13). In addition, it is obvious that the process in Step S11 may be performed after executing Step 12 and Step S13, but before executing Step 12 and Step 13 as described above, instead.

Then, according to the content of the basic setting stored in the RAM 13, information, which is desired to be turned into buttons, is detected from the information stored in the area of “information to be printed” on the RAM 13, and turned into buttons, thereby correcting the information to be printed. Then, the corrected information is stored in the area of “information to be printed” (Step S14). After that, the information stored in the area of “information to be printed” is displayed on the display 16 (Step S15). Accordingly, in addition to buttons included in input information, information corresponding to the preferable information set by the operator (such as a URL, a telephone number, and an E-mail address) is turned into buttons (for example, an underline is added thereto) and displayed.

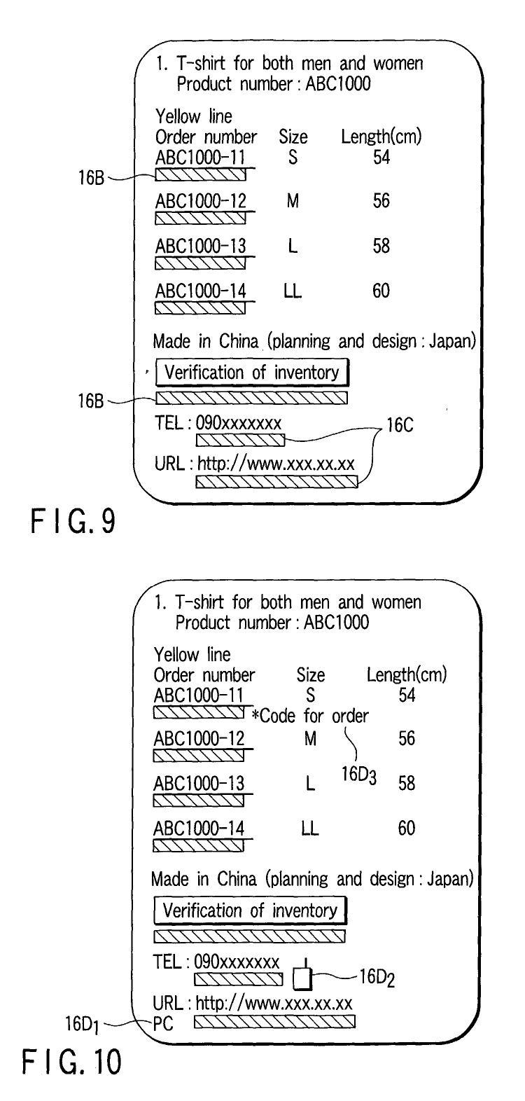

After that, by repeating processes in Step S02 to Step S05 described above, a square of a contour form 16C is displayed as shown in FIG. 9. The square 16C schematically displays a coded image corresponding to the preferable information set by the operator or the content of the preferable information near (under, for example) the preferable information (such as a telephone number “090xxxxxxx” and a “URL http://www. xxx.xx.xx”, which are information corresponding to, for example, a URL, a telephone number, and an E-mail address), while considering the size of the coded image. In Step S06, the coded image is printed on a printing medium.

The coded image 31 near, for example, a linkage icon is read optically through reading apparatus not shown out of the coded image 31 printed on the printing medium 30 in the manner described above, so that an original predetermined information (a URL in this example) is restored. The restored information is supplied to an access apparatus such as a PC, a mobile telephone, PDA etc., which is connected to the reading apparatus, and thus a linked homepage can be browsed. In the same manner, when the coded image near the URL “http://www.xxx.xx.xx” corresponding to the information preferred by the operator is read through the reading apparatus, a homepage having the URL “http://www.xxx.xx.xx” can be browsed in the access apparatus. In regard to the coded image near the telephone number “090xxxxxxx” corresponding to the preferred information selected by the operator, the coded image is read through a mobile telephone with a reading function not shown. Then, the original information (telephone number “090xxxxxxx”) is restored, so that it becomes possible to make a call without inputting the telephone number of the original number by hand through the mobile telephone with the reading function.

As described above, what kind of operations using the read information is to be performed when the coded image printed on the printing medium 30 is read, that depends on a platform of the read information. For this reason, when the coded image data are generated in Step S03, it is preferable that marks representing kinds of a platform, etc., in which the coded image can be read, are also generated and arranged near the coded image. That is, a limitation on reading the coded image 31 on the printing medium 30 is printed on the printing medium 30 as a index (mark).

FIG. 10 is a diagram showing a display example of the state where a “PC” mark 16D₁ representing that a readable platform is a PC, a mobile mark 16D₂ representing a mobile telephone are generated and laid out. In FIG. 10, the marks are not limited to marks that represent kinds of a platform in which the coded image 31 can be read, etc., but associated with the coded image as shown with a reference number 16D₃ in FIG. 10. For example, kinds of multimedia information such as text, image, voice, etc., may be the marks. Furthermore, the other attributes such as a comment on printing quality of a coded image, etc., may be the marks.

As described above, a fixed operation may be prepared in each platform on the reading side beforehand. However, if the dot code 1, which is disclosed in U.S. Pat. Nos. 5,896,403, 5,866,895, etc., wherein a physical format configuration is shown in FIG. 1, is employed as the coded image 31, then, control data for an operation to be performed in the platform can be also recorded as the coded image 31 by using a characteristic in that recoding capacity of the dot code 1 is larger in comparison with a barcode.

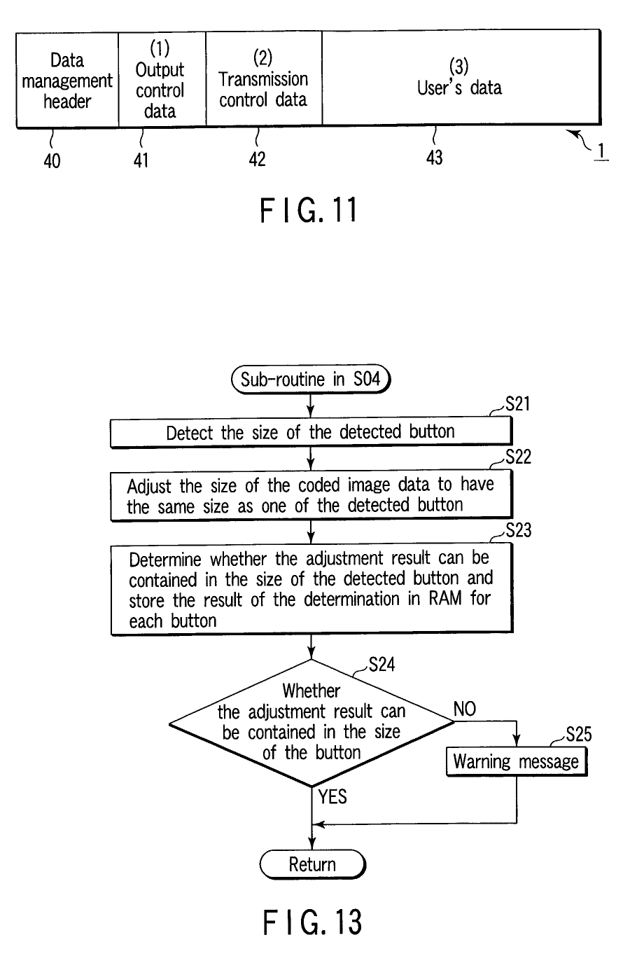

That is, a logical data structure of the dot code 1 is constituted by a data management header 40, output control data 41, transmission control data 42, and user's data 43, as shown in FIG. 11.

The data management header 40 includes various information such as kinds of data including the dot code 1, the presence/absence of compression, compression types, etc.

The output control data 41 are data used for controlling output such as an indication etc. The transmission control data 42 are information such as a URL to specify a party to be communicated through the communication section 18, or address information representing a position of information in the storage section 14, etc. The user's data 43 are data to be actually output or transmitted.

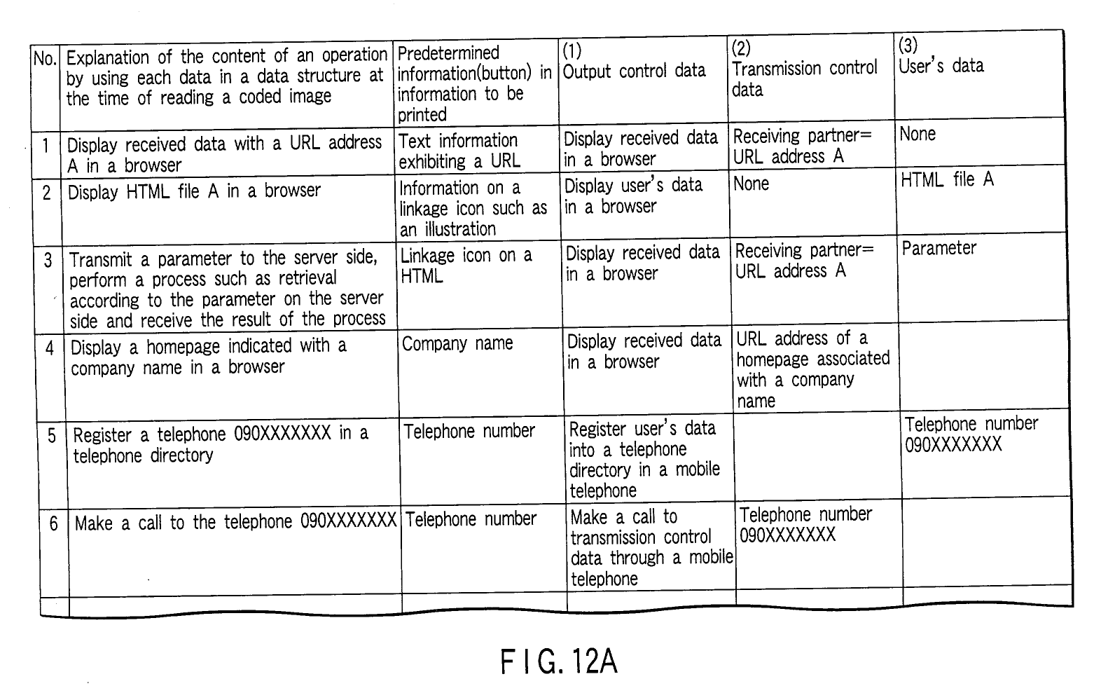

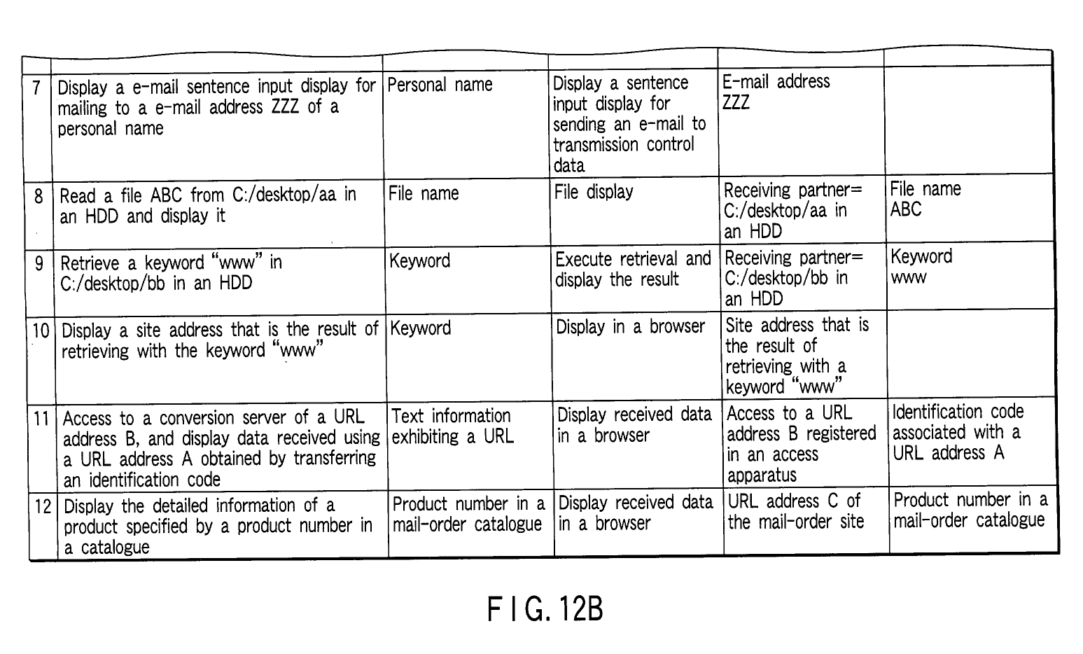

FIG. 12A and FIG. 12B are a diagram showing specific examples of predetermined information (buttons) in information to be printed, the output control data 41 corresponding to the predetermined information, transmission control data 42, and the user's data 43, for each operation at the time of reading the dot code 1 as the coded image 31 printed on the printing medium 30. The output control data 41, the transmission control data 42, and the user's data 43 of information corresponding to the predetermined information are recorded with numerical information. However, in FIGS. 12A and 12B, the data are represented with expressions indicating contents to be controlled.

That is, in the case of a coded image, which causes a platform that read the coded image to perform an operation for displaying data received with a URL address A through a browser, predetermined information is text information representing a URL. In the output control data 41, information exhibiting an operation “To display the received data in a browser” is entered, and the text information of the “URL address A” is entered into the transmission control data 42. Note that the user's data 43 do not include any data to be specially mentioned.

In this case, the predetermined information is the one when a URL is selected and specified by the basic setting in Step S11. It is not particularly shown in the drawing, however, when an operation for the specification is performed, a sub-menu for selecting and specifying what kind of operations to be further performed is displayed. Then, a preferable operation (in this case, “To display data received from the URL address A in a browser”) is selected and specified from the displayed sub-menu, so that what kinds of data are determined to be input into the output control data 41, the transmission control data 42, and the user's data 43, respectively. (The content of this paragraph will be adopted in the following.)

In the case of a coded image, which causes a platform that read the coded image to perform an operation for displaying the HTML file A in a browser, predetermined information is linkage icon image information such as an illustration. In the output control data 41, information exhibiting an operation “To display the user's data” in a browser is entered. The transmission control data 42 do not include any data to be specially mentioned. In the user's data 43, “HTML file A” is entered. When image data is attached to the HTML file A, the data are recorded in the user's data 43.

In the case of a coded image, which causes a platform that read the coded image to transmit a parameter including an argument etc. to the data base server, the data base being information resource, and causes to receive from the server the result of a process such as retrieval etc. to be performed corresponding to the parameter on the server, predetermined information is a linkage icon on the HTML, i.e., a button that executes a CGI (Common Gateway Interface) program on the server side. In the output control data 41, information exhibiting an operation “To display the received data in a browser” is entered. In the transmission control data 42, text information of “URL address A” is entered. In the user's data 43, various parameters are entered.

In the case of a coded image, which causes a platform that read the coded image to perform an operation for displaying a homepage specified with a name of company in a browser, predetermined information is a name of company. In this case, text information such as “Co., Ltd.”, etc., is detected from information to be printed in Step S14, thereby obtaining a button representing the name of company. In the output control data 41, information exhibiting an operation “To display the received data in a browser” is entered, and text information of “a URL address of a homepage associated with the name of company” is entered into the transmission control data 42. For example, the text information can be obtained through a table corresponding to a homepage associated with the name of company, the table being stored in the storage section 14 beforehand, or obtained by retrieving a homepage corresponding to the name of the company through a retrieval site on the Internet 20 by the communication section 18.

In the case of a coded image, which causes a platform that read the coded image to perform an operation for registering a telephone number 090xxxxxxx in a telephone directory, predetermined information is a telephone number. In this case, text information such as “TEL” or “telephone”, etc. is detected from information to be printed in Step S14, thereby extracting the following number of 10 digits or 11 digits as a button. Alternatively, a preferable telephone number (telephone number 090xxxxxxx, in this case) is directly input in a sub-menu in Step S1, the sub-menu being opened when “telephone number” is selected and specified, and thus, the preferable telephone number may be detected in Step S14. In the output control data 41, information exhibiting an operation “To register user's data in a telephone directory through a mobile telephone” is entered. In the user's data 43, text information on the detected telephone number “090xxxxxxx” is entered.

In the case of a coded image, which causes a platform that read the coded image to perform an operation for making a call to the telephone number 090xxxxxxx, predetermined information is text information representing “telephone number”. In the output control data 41, information exhibiting an operation “To make a call to transmission control data through a mobile telephone” is entered. In the transmission control data 42, text information on the detected telephone number “090xxxxxxx” is entered.

In the case of a coded image, which causes a platform that read the coded image to perform an operation for displaying a mail sentence input display for mailing to an E-mail address ZZZ, predetermined information is a “personal name”. In this case, a personal name can be detected in Step S14, from information to be printed by retrieving text information corresponding to personal names stored in an address directory database etc. that is prepared in the storage section 14 beforehand. In the output control data 41, information exhibiting an operation “To display a sentence input display for sending an E-mail to transmission control data” is entered. An E-mail address corresponding to the detected personal name, for example “ZZZ”, is extracted from the address directory database etc., and is entered into the transmission control data 42.

In the case of a coded image, which causes a platform that read the coded image to perform an operation for reading a file “ABC” from a “C:/desktop/aa” folder (directory) in an HDD so as to display the read file, predetermined information is a file name. In this case, text information showing, for example, an extension of “.***” is detected from information to be printed in Step S14, so that a series of character strings including the text information can be extracted as a button. Alternatively, in Step S11, a preferable extension or a preferable file name may be directly input in a sub-menu that is opened when the “file name” is selected and specified, instead. In the output control data 41, information exhibiting an operation “To display a file” is entered. In the transmission control data 42, text information of “C:/desktop/aa in an HDD” is entered. In the user's data 43, a detected file name, such as “ABC”, for example, is entered.

In the case of a coded image, which causes a platform that read the coded image to perform an operation for retrieving a keyword “www” in a “C:/desktop/bb” folder in an HDD, predetermined information is a keyword. In this case, for example, text information “keyword” is detected from information to be printed in Step S14, so that a series of character strings including the keyword can be extracted as a button. Alternatively, in Step S11, a preferable keyword, “www” in this case, may be directly input in a sub-menu that is opened when the “keyword” is selected and specified in Step Sil, instead. In the output control data 41, information exhibiting an operation “To execute retrieval and display the result” is entered. In the transmission control data 42, text information on “C:/desktop/bb in an HDD” is entered. In the user's data 43, a detected keyword, “www”, for example, is entered.

In the case of a coded image, which causes a platform that read the coded image to perform an operation for displaying a site address, which is the result of the retrieval with a keyword “www”, predetermined information is a keyword. In the output control data 41, information exhibiting an operation “To display in a browser” is entered. In the transmission control data 42, text information on a “site address (URL)” is entered. The text information is obtained by retrieving with the detected keyword, “www”, for example, in the Internet 20 through the communication section 18.

In the case of a coded image, which causes a platform that read the coded image to access the conversion server 22 with a URL address B, and to perform an operation for displaying data received from the target site 21 with a URL address A, which is obtained by transmitting a identification code to the conversion server 22, in a browser, predetermined information is “text information exhibiting URL”. In the output control data 41, information exhibiting an operation “To display the received data in a browser” is entered. In the transmission control data 42, information exhibiting an operation “To access a URL address B registered in an access apparatus” is entered. In this case, in the user's data 43, an identification code relating to the URL address A is entered. The identification code corresponds to the URL detected from information to be printed and is retrieved from a conversion table etc. stored in the storage section 14, thereby being entered into the user's data 43.

In the case of a code image, which causes a platform that read the coded image to perform an operation for displaying the detailed information (price, for example) of a product that is specified with a product number in a mail-order catalogue, predetermined information is a product number in a mail-order catalogue. In the output control data 41, information exhibiting an operation “To display the received data in a browser” is entered. In the transmission control data 42, text information on “URL address C of the mail-order site” that is stored in the storage section 14 beforehand, for example, is entered. In the user's data 43, the extracted product number in the catalogue is entered.

In addition, information to be coded and turned into an image may be sound or an image. Further, a party to be transmitted may be a server or a site on the Internet 20 accessed via the communication section 18, or may be the storage section 14.

Next, adjustment of the coded image size in Step S04 will be described with reference to FIG. 13.

Firstly, the size of the button detected in Step S02 is detected (Step S21). In the case that the button that is predetermined information is text information, the length of character string of the text information is detected as the size of the button. The length is calculated from information on the font kind of the characters, information on the point size, information on the distance between characters, information on the number of the character strings, etc. In the case that the button that is the predetermined information is image data, the size of the button is calculated from information on resolution of the image data, and information on the size of the image.

Next, the size of the coded image data generated in Step S03 is adjusted so as to have the same size as the detected button (Step S22). Then, it is determined whether or not the result of the adjustment is contained in the size of the detected button, and the result of the determination is stored in the RAM 13 for each button (Step S23).

After that, when the result of the adjustment is contained in the size of the detected button (Step S24), a procedure proceeds to Step S05 directly. On the other hand, the result cannot be contained in the size of the button (Step S24), a warning message is given on the display section 16 (Step S25), and a procedure proceeds to Step S05.

In the present embodiment, in regard to the printing in Step S06, all of the coded image data generated in Step S04 is not printed, but the coded image data passing the restriction, which is placed by an operator, can be printed.

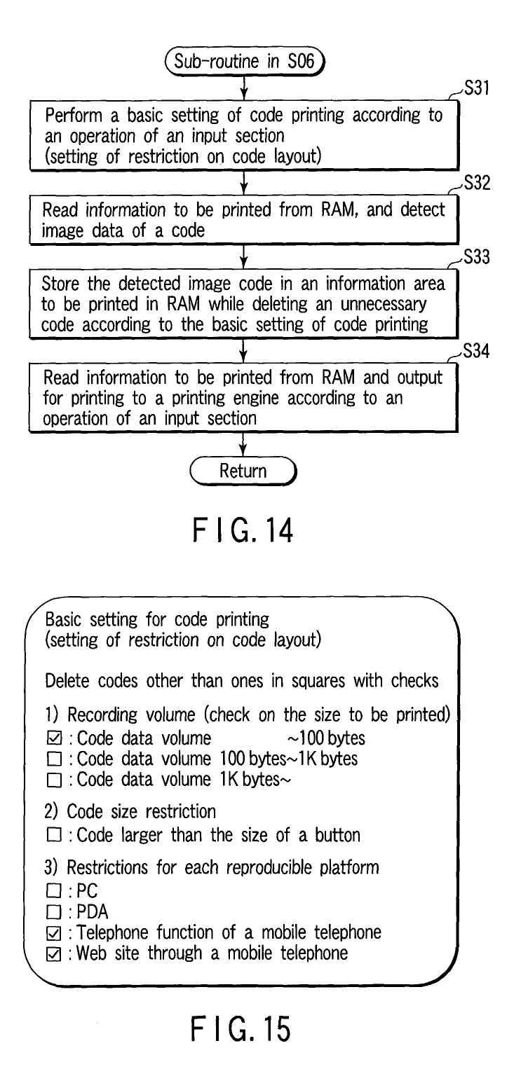

This process will be described with reference to the flowchart shown in FIG. 14.

A basic setting for code printing is performed as a layout restriction setting of a code that is a coded image according to an operation of the input section 15 (Step S31). FIG. 15 is a diagram showing a display example of a basic setting for the code printing. In the display of the basic setting for the code printing, the setting is divided into three items, i.e., recording capacity, code size restriction, and restriction on each reproducible platform. A plurality of selective items can be set in the respective items.

The recording capacity exhibits the capacity of data to be recorded in a code, through which it is selected whether or not to print the code for each capacity of the data. This corresponds to the case where the code size is limited in code formatting in that the code size varies according to the capacity. In addition, when the code size is large, setting can be changed in consideration that a reading apparatus cannot read easily.

The code size restriction selects whether or not to print depending on the fact that the code is contained in the size of the button, and reads the result of the determination stored in Step S23 shown in FIG. 13, thereby determining.

In regard to the restriction for each reproducible platform, there is the case that a platform that reads the generated code can output (display) and the case that the platform cannot output. Therefore, the image data of the code that outputs the HTML file that can be read by only a PC or PDA can be deleted on the premise of reading through a telephone with a code reading function.

For example, according to the example shown in FIG. 15, a platform is a mobile telephone, and only a code whose capacity of 100 Bytes or less is remained. A file that is read by only the PC or PDA is deleted, and further, a code whose capacity larger than 100 Bytes or above is deleted.

After performing the basic setting on the basic setting display of such a code printing, information to be printed is read by the RAM 13, and then, the image data of the code is detected from the read information (Step S32). After that, an unnecessary code in the image data of the detected code is deleted according to the basic setting for the code printing, and stored in an information area to be printed on the RAM 13 (Step S33).

After that, information to be printed is read from the RAM 13, and output for printing to the printing engine 17 according to on operation of the input section 15 (Step S34).

The invention has been described based on the embodiment. However, the invention is not limited to the embodiment described above. It is obvious that the invention can also be modified within its spirit and scope.

The following are the points of the invention.

(1) A printing image data generating method for generating printing image data from information to be printed so as to print the information on a printing medium, comprising:

detecting predetermined information from the information to be printed; and

coding one of the detected predetermined information and information corresponding to the detected predetermined information, thereby generating data of a coded image that can be optically read.

That is, information to be input at the time of generating a coded image is detected from information to be printed, so that a task of the input executed by an operator can be reduced. Further, it becomes possible to reduce input mistakes and easily produce a printed matter including a coded image.

Recently, in an application program such as a Web browser, spread is a technology that reads a file other than a displayed file by selecting a button included in the displayed file, due to a method, which is called a hyperlink. However, the other file cannot be easily read from a printed matter at the time of printing the displayed file. According to the method (1), it becomes possible to easily produce a printed matter including a coded image that can easily read the other file from a file displayed in the Web browser.

(2) The method according to (1), further comprising arranging a coded image of the generated data to have a predetermined positional relation to the predetermined information on the printing medium.

That is, in addition to the effect provided by (1), it becomes possible to further easily produce a printed matter including a coded image by automatically arranging a coded image.

In addition, the contents of plural coded images cannot be identified on a display, and a mistake of arranging at the time of producing a printed matter including coded images occurs easily. However, it is possible to eliminate a mistake of arranging by automatic layout. Further, a process of checking a mistake of arranging can be omitted.

(3) The method according to (2), wherein, when the predetermined information is text information, arranging the coded image includes arranging the coded image under the text information.

That is, in addition to the effect provided by (2), a coded image is automatically laid out under text information. And thus, the relation between the text information and the coded image becomes easy to find visually, which simplifies check in mistakes of layout.

Further, it is possible to provide the layout through which an operator reading the coded image through a reading apparatus on a printed matter can easily identify the relation between the text information and a coded image visually.

In many cases, a margin that is a non-printing area is arranged under text information. When the coded image is automatically laid out in the margin, information other than the coded image does not overlap. Therefore, it is possible to reduce layout correction, for example, changing layout of the coded image as little as possible.

(4) The method according to (3), wherein generating data of the coded image includes generating data of the coded image to have the same length as one of the text information to be printed.

That is, in addition to the effect provided by (3), it is possible to recognize visually the text information associated with a coded image stably, and improve looks of a printed matter.

(5) The method according to one of (1) to (4), wherein the information corresponding to the predetermined information is a uniform identification code corresponding to the predetermined information.

That is, in addition to the effect of (1), (2), (3) or (4), the identification code is associated with a URL of a site, for example, which makes it easy to output the information on the site by reading the generated coded image.

(6) The method according to one of (1) to (5), wherein detecting the predetermined information includes setting the predetermined information.

That is, in addition to the effect of (1), (2), (3) (4) or (5), the predetermined information can be set, so that the predetermined information that is desired to be printed as a coded image can be set as desired. In addition, setting the predetermined information improves speed of processing.

(7) The method according to (6), wherein the setting includes selection of the predetermined information and cancellation of the selection.

That is, in addition to the effect of (6), by performing the selection or cancellation of the predetermined information, the predetermined information that is desired to be printed as a coded image can be restricted. In addition, this restriction improves speed of processing.

(8) The method according to one of (1) to (5), wherein generating data of the coded information includes deleting data of the generated coded image.

That is, in addition to the effect of (1), (2), (3), (4) or (5), by deleting the data of the generated coded image, a coded image to be printed can be restricted as it is desired. This restriction improves a function of layout.

(9) The method according to one of (1) to (5), wherein the information corresponding to the predetermined information includes linkage information for linking to a predetermined information resource corresponding to the predetermined information.

That is, in addition to the effect of (1), (2), (3), (4) or (5), information corresponding to the predetermined information is assumed to be linkage information, so that it becomes possible to easily link to a predetermined information resource corresponding to the predetermined information.

(10) The method according to one of (1) to (5), wherein the information corresponding to the predetermined information includes a retrieval keyword for performing a retrieval process to the predetermined information from a predetermined database.

That is, in addition to the effect of (1), (2), (3), (4) or (5), information corresponding to the predetermined information is assumed to be a retrieval keyword relating to the predetermined information, so that it becomes possible to perform a retrieval process easily from the predetermined database. (11) A printing image data generating apparatus for generating printing image data from information to be printed so as to print the information on a printing medium, comprising:

a detecting section for detecting predetermined information from the information to be printed; and

a coded image data generating section for coding one of the predetermined information detected at the detecting section and information corresponding to the predetermined information detected at the detecting section so as to generate data of a coded image that can be optically read.

That is, information to be input at the time of generating a coded image is detected from information to be printed, so that a task of the input executed by an operator can be reduced. Further, it becomes possible to reduce input mistakes and easily produce a printed matter including a coded image.

Recently, in an application program such as a Web browser, spread is a technology that reads a file other than a displayed file by selecting a button included in the displayed file, due to a method, which is called a hyperlink. However, the other file cannot be easily read from a printed matter at the time of printing the displayed file. According to the apparatus (11), it becomes possible to easily produce a printed matter including a coded image that can easily read the other file from a file displayed in the Web browser.

(12) The apparatus according to (11), further comprising a layout section for laying out a coded image of data generated by the coded image data generating section to have a predetermined positional relation to the predetermined information on the printing medium.

That is, in addition to the effect provided by (11), it becomes possible to further easily produce a printed matter including a coded image by automatically arranging a coded image.

In addition, the contents of plural coded images cannot be identified on a display, and a mistake of arranging at the time of producing a printed matter including coded images occurs easily. However, it is possible to eliminate a mistake of arranging by automatic layout. Further, a process of checking a mistake of arranging can be omitted.

(13) A program for causing a computer to realize the following functions at the time of generating printing image data from information to be printed so as to print the information on a printing medium, the functions comprising:

detecting predetermined information from the information to be printed; and

coding one of the detected predetermined information and information corresponding to the detected predetermined information so as to generate data of a coded image that can be optically read.

That is, information to be input at the time of generating a coded image is detected from information to be printed, so that a task of the input executed by an operator can be reduced. Further, it becomes possible to reduce input mistakes and easily produce a printed matter including a coded image.

Recently, in an application program such as a Web browser, spread is a technology that reads a file other than a displayed file by selecting a button included in the displayed file, due to a method, which is called a hyperlink. However, the other file cannot be easily read from a printed matter at the time of printing the displayed file. According to the program (13), it becomes possible to easily produce a printed matter including a coded image that can easily read the other file from a file displayed in the Web browser.

(14) The program according to (13), wherein the functions further comprises laying out a coded image of the generated data to have a predetermined positional relation to the predetermined information on the printing medium.

That is, in addition to the effect provided by (13), it becomes possible to further easily produce a printed matter including a coded image by automatically arranging a coded image.

In addition, the contents of plural coded images cannot be identified on a display, and a mistake of arranging at the time of producing a printed matter including coded images occurs easily. However, it is possible to eliminate a mistake of arranging by automatic layout. Further, a process of checking a mistake of arranging can be omitted.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. A printing image data generating method for generating printing image data from information to be printed so as to print the information on a printing medium, comprising:
detecting predetermined information from the information to be printed; and
coding one of the detected predetermined information and information corresponding to the detected predetermined information, thereby generating data of a coded image that can be optically read.

2. The method according to claim 1, further comprising arranging a coded image of the generated data to have a predetermined positional relation to the predetermined information on the printing medium.

3. The method according to claim 2, wherein, when the predetermined information is text information, arranging the coded image includes arranging the coded image under the text information.

4. The method according to claim 3, wherein generating data of the coded image includes generating data of the coded image to have the same length as one of the text information to be printed.

5. The method according to claim 1, wherein the information corresponding to the predetermined information is a uniform identification code corresponding to the predetermined information.

6. The method according to claim 1, wherein detecting the predetermined information includes setting the predetermined information.

7. The method according to claim 6, wherein the setting includes selection of the predetermined information and cancellation of the selection.

8. The method according to claim 1, wherein generating data of the coded information includes deleting data of the generated coded image.

9. The method according to claim 1, wherein the information corresponding to the predetermined information includes linkage information for linking to a predetermined information resource corresponding to the predetermined information.

10. The method according to claim 1, wherein the information corresponding to the predetermined information includes a retrieval keyword for performing a retrieval process to the predetermined information from a predetermined database.

11. A printing image data generating apparatus for generating printing image data from information to be printed so as to print the information on a printing medium, comprising:
a detecting section for detecting predetermined information from the information to be printed; and
a coded image data generating section for coding one of the predetermined information detected at said detecting section and information corresponding to the predetermined information detected at said detecting section so as to generate data of a coded image that can be optically read.

12. The apparatus according to claim 11, further comprising a layout section for laying out a coded image of data generated by said coded image data generating section to have a predetermined positional relation to the predetermined information on the printing medium.

13. A program for causing a computer to realize the following functions at the time of generating printing image data from information to be printed so as to print the information on a printing medium, the functions comprising:
detecting predetermined information from the information to be printed; and
coding one of the detected predetermined information and information corresponding to the detected predetermined information so as to generate data of a coded image that can be optically read.

14. The program according to claim 13, wherein the functions further comprises laying out a coded image of the generated data to have a predetermined positional relation to the predetermined information on the printing medium.
